(19) United States
(12) Patent Application Publication
(10) Pub. No.: US 2013/0080971 A1
(43) Pub. Date: Mar. 28, 2013

(54) SAVING AND RETRIEVING COMMAND SETTINGS IN A COMMAND WINDOW

(71) Applicant: Jonathan Gray, Pulborough (GB)

(72) Inventor: Jonathan Gray, Pulborough (GB)

(73) Assignee: SIEMENS PRODUCT LIFECYCLE MANAGEMENT SOFTWARE INC., Plano, TX (US)

(21) Appl. No.: 13/245,968

(22) Filed: Sep. 27, 2011

(51) Int. Cl. G06F 3/048

(52) U.S. Cl. 715/806

(57) ABSTRACT

Product Data Management systems, methods, and mediums. A method includes receiving a plurality of parameters into a command window. The method includes storing the plurality of parameters and a layout of the command window. The method includes retrieving the plurality of parameters and the layout of the command window in response to a user request and displaying the plurality of parameters in a second command window based on the layout of the command window.

### TECHNICAL FIELD

The present disclosure is directed, in general, to computer-aided design, visualization, and manufacturing systems (“CAD systems”), product lifecycle management (“PLM”) systems, and similar systems, that manage data for products and other items (individually and collectively, product data management systems (“PDM”) systems).

### BACKGROUND OF THE DISCLOSURE

PDM systems can provide users with helpful and intuitive views of systems, objects, topologies, and other items.

### SUMMARY OF THE DISCLOSURE

Various disclosed embodiments relate to systems and methods for saving and retrieving a command configuration in a command window.

Various embodiments include PDM systems, methods, and mediums. A method includes receiving a plurality of parameters into a command window. The method includes storing the plurality of parameters and a layout of the command window. The method includes retrieving the plurality of parameters and the layout of the command window in response to a user request and displaying the plurality of parameters in a second command window based on the layout of the command window.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 illustrates an example of a command window in accordance with disclosed embodiments;

FIG. 3 illustrates an example of a menu in a command window in accordance with disclosed embodiments:

FIG. 4 illustrates an example of a dialog menu displaying a list of saved command configurations in accordance with disclosed embodiments; and

FIG. 5 depicts a flowchart of a process in accordance with disclosed embodiments.

### DETAILED DESCRIPTION

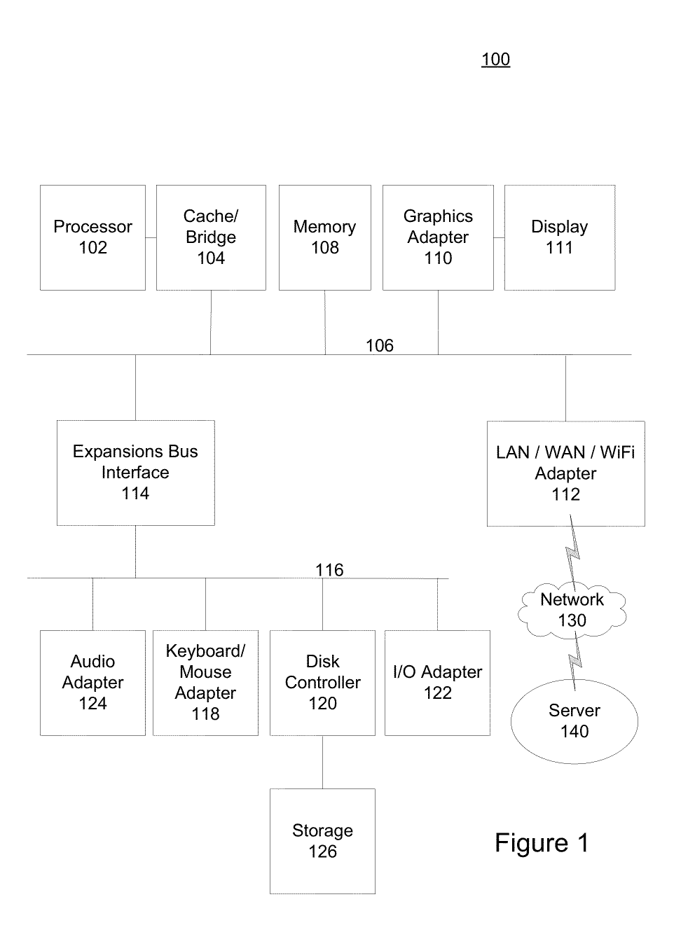

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Typical command or “dialog” windows in CAD systems require the user to specify numerous parameters to control aspects of creating, modifying, and reviewing objects. For example, command windows may require different parameters for numbers, values, settings, or options in various fields or drop-down lists be input into the command window. The parameters and layout of the command window for a particular command are a configuration for the command. The parameters provide detail and control for commands performed by the CAD system.

In situations where multiple commands are used, the parameters entered into the command window may change over time. If a user desires to repeat certain commands previously used, productivity may be hindered as the user repeatedly provides the same inputs to configure the command window for the desired commands.

Disclosed embodiments provide end users the ability to save command configurations that can subsequently be restored to a command window. Saving the command configurations can provide the user all parameters needed to repeat a desired command. Disclosed embodiments can save and retrieve multiple command configurations for a particular command. The disclosed embodiments can place retrieved configurations in the command window in a layout similar to the saved configuration. The saving and retrieval of command configurations for particular commands is not supported in known CAD systems.

The various embodiments discussed in more detail below include improved systems and methods for systems and methods for saving and retrieving command configurations in a command window.

FIG. 1 depicts a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments can be implemented using data processing systems 100 to save and retrieve command configurations for creating, modifying, and reviewing objects. For example, a layout of the command window and parameters input for a command may be present in memory allocated to a current session when a user commits the command. The various embodiments of the present disclosure allow the user to save the parameters and the layout information for the command being used into a file that is separate from the current session. The various embodiments of the present disclosure can provide that particular set of data to the same command window at a later point in time during the session or to another command window during another session. The various embodiments of the present disclosure allow the user to save and reuse often-used command configurations including a layout of the command window, reducing the need to re-enter values for often-used commands.

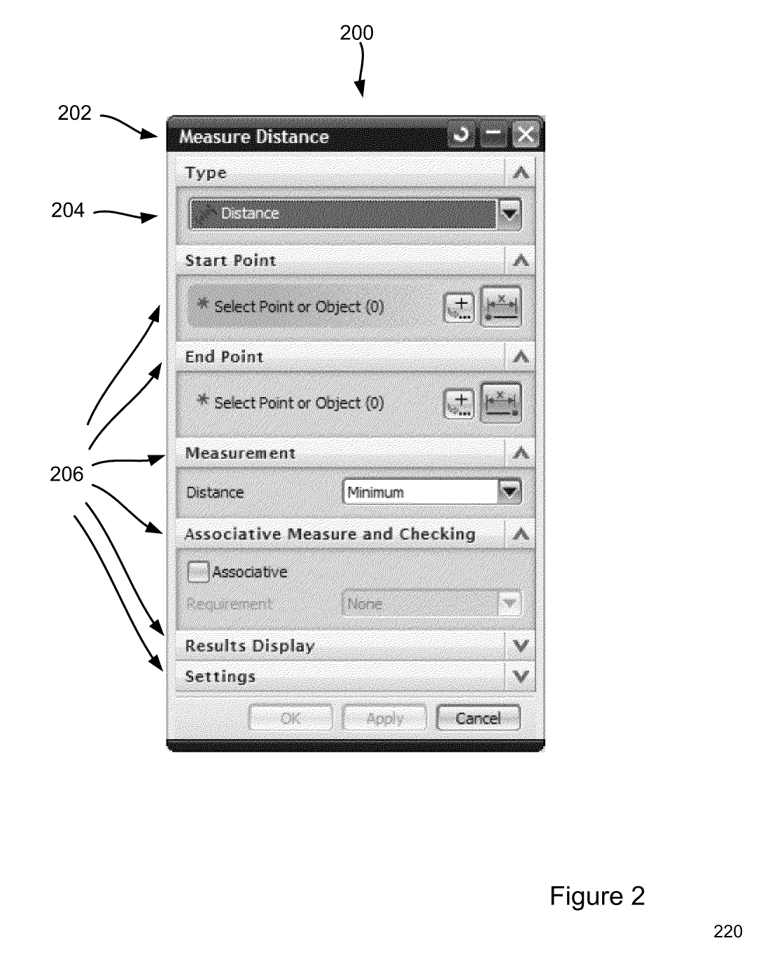

FIG. 2 illustrates an example of a command window 200 in accordance with disclosed embodiments that can be implemented, for example, by one or more data processing systems 100, referred to in the singular as “the system.” For example, the system can generate command window 200 and display command window 200 on display 111 in FIG. 1.

Command window 200 allows a user to input or modify a type 202 of command 204 and various parameters 206 associated with the command 204. For example, the user can input the types, selections, values, and/or settings for command 204. The user can also expand, collapse, and hide groups on command window 200 for a particular use.

In this illustrated example, the system may use command 204 to measure a distance on an object. In one example, command 204 may be a user interface framework (UIFW) command in a CAD system. The system processes command 204 and returns a measurement of a distance between points and/or objects present in the CAD system. If a user wants to use a different command, the user would change type 202 to that of the different command. The user may also change parameters 206 in command window 200 to control and specify details for the different command.

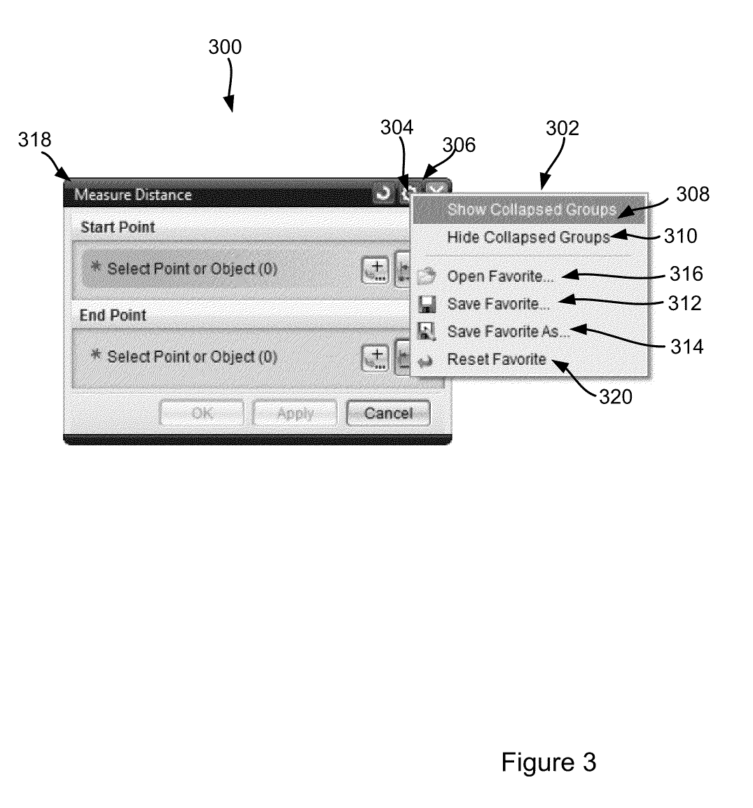

FIG. 3 illustrates an example of a menu in a command window in accordance with disclosed embodiments that can be implemented, for example, by one or more data processing systems 100, referred to in the singular as “the system.” Command window 300 is an example of one implementation of command window 200 in FIG. 2. For example, the system may use command window 300 to measure distance,

In this illustrated example, command window 300 includes menu 302. The system may display menu 302 to a user when the user selects button 304 on bar 306. Menu 302 provides users with multiple options regarding command window 302. Selection of options 308 and 310 cause the system to permit showing and hiding of collapsed groups, respectively. For example, selection of option 308 shows groups of parameters that the user can modify within command window 300, as shown, for example, in command window 200 in FIG. 2. Selection of option 308 hides or collapses groups of parameters for reducing the size of command window 300. In some embodiments, options 308 and 310 may not be included in menu 302. In some embodiments, options 308 and 310 may not be included in menu 302.

Upon selection of option 312, the system saves the configuration of command window 300 as a “favorite.” As discussed above, the system maintains user inputs of parameters, types of commands, and a layout of command window 300 in memory for a current session. Upon selection of option 312, the system stores data associated with command window 300 in a separate file that a user can access during later sessions. For example, the system may maintain data for command window 300 in a portion of memory 108 allocated to a CAD application session running on data processing system 100 in FIG. 1. Upon selection of option 312, the system may store data for command window 300 in a file in storage 126 that is separate from the current session. Further, when saved, the system may provide other users and or data processing systems access to the file. For example, the file may be stored in server system 140 and accessible to users via network 130 in FIG. 1.

Upon selection of option 314, the system allows the user to name the file where the system will save the command configuration. For example, if the system had not yet saved the command configuration, upon selection of option 314 the system allows the user to enter a name for the command configuration as a new favorite. The system will then save the configuration under the name entered. For example, the system may save the configuration in a file directory. In another example, the system may save the configuration in any suitable location. Additionally, if a user made changes to command window 300 after a previous save, upon selection of option 314, the system saves the command configuration as a new configuration for the command.

Upon selection of option 316, the system retrieves a previously saved command configuration. For example, upon selection of option 316, the system presents the user with a file directory from which the user may retrieve previously saved command configurations. In another example, the system may present a dialog menu from which the user may retrieve previously saved command configurations. Based on access level, the user may have access to their own previously saved command configurations, those of a predefined group of users, and those of an entire site.

When a user selects a command configuration, the system places data from the selected configuration into command window 300. For example, the system may add to or modify in command window 300 the type of command and parameters associated with the command. In another example, the system may generate a new command window having the type of command and parameters of the selected configuration. For example, a button may be present in user interface for loading a command into a new command window. Upon selection of the button, the system can present the dialog menu with saved configurations and present the selected configuration in the new command window generated. If no command configuration had been previously saved, option 316 may not be present in menu 302. Once the system loads a command configuration, the system may change dialog title 318 to the name of the retrieved configuration.

For example, without limitation, the parameters associated with the command may include values input into certain fields, selections from a drop-down list, settings for a particular command, selections for results display, and/or options for a particular command. Upon selection of a command configuration, the system can restore each input for the saved parameters to a command window. For example, the system may populate values into the certain fields, select options from a drop-down list, and select or deselect settings and options for a particular command or results display.

In various embodiments, command configurations not only save parameters and values for commands but may also save the layout and state of a command window. Thus, upon retrieval of a saved configuration, the system may modify command window 300 based on the layout and state of a command window. For example, the system may modify command window 300 to resemble the layout and/or state of the previously saved command window. For example, the system may hide or show certain groups of parameters as in a previously saved command window.

Upon selection of option 320, the system returns a user to a previously used command configuration. For example, a user may have retrieved a command configuration in command window 300. Upon selection of option 320, the system returns command window 300 to a state prior to the retrieval of the configuration. For example, the system may retrieve the configuration of command window 300 prior to retrieval of a saved configuration from memory for the current session. Upon selection of option 320, the system also changes dialog title 318 back to a standard name for a command in command window 300.

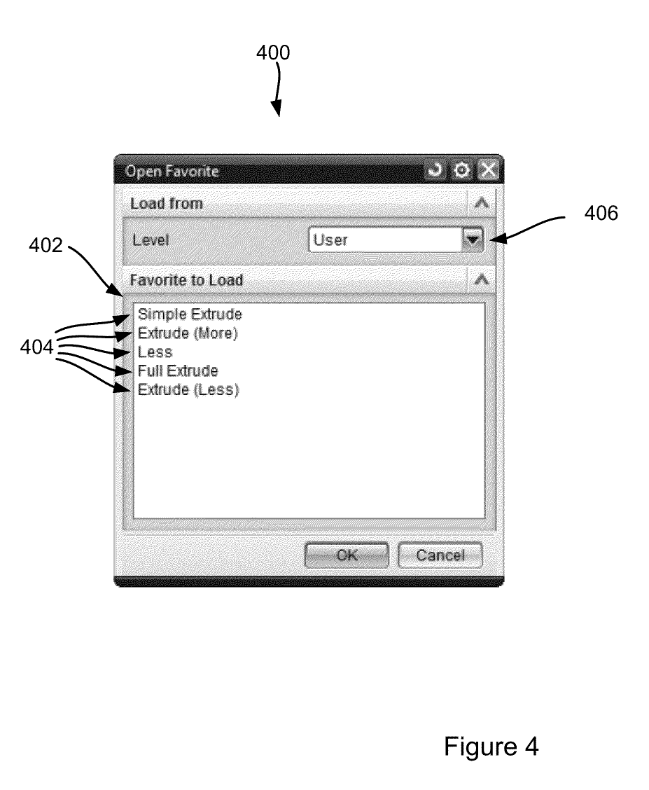

FIG. 4 illustrates an example of a dialog menu 400 displaying a list of saved command configurations in accordance with disclosed embodiments that can be implemented, for example, by one or more data processing systems 100, referred to in the singular as “the system.” For example, the system may display dialog menu 400 as window on display 111 in FIG. 1. The system may display dialog menu 400 whenever a user desires to retrieve a command configuration for a command window. For example, the system may display dialog menu 400 the system receives a user selection of option 316 from menu 302 in FIG. 3. In other examples, the system may provide access to dialog menu 400 upon receiving a selection from a menu entry or toolbar button.

In this illustrated example, dialog menu 400 includes list 402 of command configurations 404 that the system can load in response to a user selection. In this illustrative example, a command for “extrude” has multiple different saved command configurations. In other examples, the system may include saved command configurations for other types of commands.

Dialog menu 400 also includes level 406. For example, a command may have different saved configurations for a different selection of level 406. Examples of different types of levels include command configurations for a user, a group, and a site. Upon selection of a type of level 406, the system displays saved command configurations for the selected level.

To load a command configuration, the system receives a user selection of a desired command configuration from command configurations 404 displayed in dialog menu 400. Upon selection of one of command configurations 404, the system loads data from the selected configuration into a command window and configures the command window to display the parameters and layout of the command window at the time the selected configuration was saved. Once the system has retrieved a command configuration, the command window will operate the same as the originally saved command window.

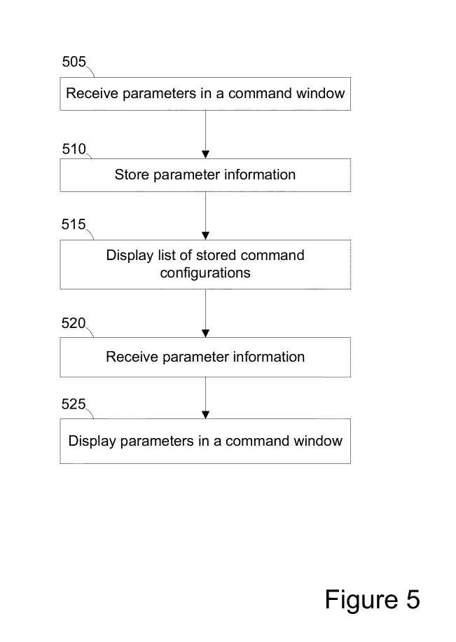

FIG. 5 depicts a flowchart of a process in accordance with disclosed embodiments. This process can be performed, for example, by one or more PDM data processing systems configured to perform acts described below, referred to in the singular as “the system.” The process can be implemented by executable instructions stored in a non-transitory computer-readable medium that cause one or more PDM data processing systems to perform such a process.

The system receives parameters in a command window (step 505). “Receiving,” as used herein, can include loading from storage, receiving from another device or process, or receiving through an interaction with a user. For example, as part of this step, the system may receive a type of command and values for a number of different controls associated with the command.

The system stores the parameters and a layout of the command window (step 510). The system stores the data from the command window in a file that is separate from data for the current session. As part of this step, the system may store the data for the command window in response to a user request to save the command window as a favorite.

The system can display a list of stored command configurations in a menu (step 515). As part of this step, the system may display menu in response to a request to retrieve a previously saved command configuration.

The system receives the parameters and the layout of the command window (step 520). The system may load the saved data from a selected command configuration into the current session in response to a user request.

The system displays the parameters in a command window based on the layout of the command window (step 525). The layout of the previously saved command window may be included in a current command window. For example, the system may replicate a layout of the previous command window in the current command window. As part of this step, the system may generate a new command window and place the plurality of parameters in the new command window. In another example, the system may include the parameters with parameters input into the currently displayed command window.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by a product data management (PDM) data processing system, comprising:
receiving a plurality of parameters in a command window;
storing the plurality of parameters and a layout of the command window;
receiving the plurality of parameters and the layout of the command window in response to a user request; and
displaying the plurality of parameters in a second command window based on the layout of the command window.

2. The method of claim 1, wherein the PDM data processing system displays the plurality of parameters in the second command window by generating a new command window based on the layout of the command window and placing the plurality of parameters in the new command window.

3. The method of claim 1, wherein the second command window is a currently displayed command window and wherein the PDM data processing system includes the plurality of parameters with parameters input into the currently displayed command window.

4. The method of claim 1, wherein the PDM data processing system stores the plurality of parameters and the layout of the command window in a file that is separate from data for a current session.

5. The method of claim 1, wherein the PDM data processing system displays a list of stored command configurations in a menu response to a user request to retrieve a stored command configuration.

6. The method of claim 1, wherein the plurality of parameters includes a type of command and values for a number of different controls associated with the command.

7. The method of claim 1, wherein the PDM data processing system stores the plurality of parameters and the layout of the command window in response to a user request to save the command window as a favorite.

8. A product data management (PDM) data processing system comprising:
a processor; and
an accessible memory, the data processing system particularly configured to
receive a plurality of parameters in a command window;
store the plurality of parameters and a layout of the command window;
receiving the plurality of parameters and the layout of the command window in response to a user request; and
display the plurality of parameters in a second command which based on the layout of the command window.

9. The PDM data processing system of claim 8, wherein the PDM data processing system displays the plurality of parameters in the second command window by generating a new command window based on the layout of the command window and placing the plurality of parameters in the new command window.

10. The PDM data processing system of claim 8, wherein the second command window is a currently displayed command window and wherein the PDM data processing system includes the plurality of parameters with parameters input into the currently displayed command window.

11. The PDM data processing system of claim 8, wherein the PDM data processing system stores the plurality of parameters and the layout of the command window in a file that is separate from data for a current session.

12. The PDM data processing system of claim 8, wherein the PDM data processing system displays a list of stored command configurations in a menu response to a user request to retrieve a stored command configuration.

13. The PDM data processing system of claim 8, wherein the plurality of parameters includes a type of command and values for a number of different controls associated with the command.

14. The PDM data processing system of claim 8, wherein the PDM data processing system stores the plurality of parameters and the layout of the command window in response to a user request to save the command window as a favorite.

15. A non-transitory computer-readable medium encoded with executable instructions that, when executed, cause one or more product data management (PDM) data processing systems to:
receive a plurality of parameters in a command window;
store the plurality of parameters and a layout of the command window;
receiving the plurality of parameters and the layout of the command window in response to a user request; and
display the plurality of parameters in a second command window based on the layout of the command window.

16. The computer-readable medium of claim 15, wherein the instructions that cause the PDM data processing system to display the plurality of parameters in the second command window comprise instructions that cause the PDM data processing system to generate a new command window based on the layout of the command window and place the plurality of parameters in the new command window.

17. The computer-readable medium of claim 15, wherein the second command window is a currently displayed command window and wherein the instructions cause the PDM data processing system to include the plurality of parameters with parameters input into the currently displayed command window.

18. The computer-readable medium of claim 15, wherein the instructions cause the PDM data processing system to store the plurality of parameters and the layout of the command window in a file that is separate from data for a current session.

19. The computer-readable medium of claim 15, wherein the instructions cause the PDM data processing system to display a list of stored command configurations in a menu response to a user request to retrieve a stored command configuration.

20. The computer-readable medium of claim 15, wherein the plurality of parameters includes a type of command and values for a number of different controls associated with the command.
